(19) United States
(12) Patent Application Publication
(10) Pub. No.: US 2015/0028753 A1
(43) Pub. Date: Jan. 29, 2015

(54) LED LIGHTING DEVICE

(71) Applicant: CHUNIL CO., LTD., Gyeonggi-do (KR)

(72) Inventor: Young Ha Kim, Incheon (KR)

(21) Appl. No.: 14/345,214

(22) PCT Filed: Apr. 19, 2013
(86) PCT No.: PCT/KR2013/003359

§ 371 Date: Mar. 14, 2014

(30) Foreign Application Priority Data
Apr. 20, 2012 (KR) 10-2012-0041661

(51) Int. Cl. H05B 33/08

(52) U.S. Cl. CPC H05B 33/0815; H05B 33/0821; H05B 33/0848
USPC 315/186

(57) ABSTRACT

The present disclosure relates to a technology or improving the efficiency of light emitting diode (LED) elements and extending the lifespan thereof, significantly reducing cost and improving efficiency of a power supply while supplying sufficient LED driving power to an LED lamp module without the use of an output-side electrolytic capacitor need in a converter, and extending the lifespan of the converter. Consequently, the present disclosure relates to a technology of reducing product cost and maintenance cost and extending the lifespan of an LED lighting device.

### TECHNICAL FIELD

The present disclosure relates to a technology of extending lifespan of a light emitting diode (LED) module and a power supply, that is, a converter, constituting LED lighting devices including an LED streetlight.

More specifically, the present disclosure relates to a technology of improving the efficiency of LED elements and extending the lifespan thereof, significantly reducing cost and improving efficiency of the power supply while supplying sufficient LED driving power to the LED lamp module without the use of an output-side electrolytic capacitor used in the converter, and extending the lifespan of the converter. Accordingly, the present disclosure relates to a technology of reducing product cost and maintenance cost and extending the lifespan of LED lighting devices.

### BACKGROUND ART

In general, the following two factors may affect lifespan of a light emitting diode (LED) lighting device:

First, one factor is the luminous efficiency of LED elements constituting an LED lamp module of the LED lighting device and the heat-generation temperature, that is, a junction temperature (Tj° C.) at bases of the LED elements when the LED elements to which the luminous efficiency is applied are driven. In general, the lifespan of a converter is considerably shorter than that of an LED element. That is the lifespan of this LED module power supply (the converter) may be considered as the lifespan of the LED lighting device.

Second, the other factor is the lifespan of the power supply, that is, the converter, supplying driving power to the LED lamp module. The present invention relates to the configuration of the LED lamp module to which optimal driving conditions required by the LED elements are applied, and also relates to a heat radiation technology for reducing the junction temperature of the LED elements.

A high-capacity LED lighting device including an LED streetlight consumes hundreds watt of power, unlike interior lights. In order to form this lighting device, tens to hundreds of LED elements are necessarily used to constitute the LED lamp module. Here, when the LED module is configured with a general power supply, output voltage of the power supply, DC 12V to DC 24V, may be utilized as driving voltage of the LED lamp module. In this case, the LED elements may be configured through series or parallel connections according to capacity of the lighting device.

FIG. 1 illustrates the configuration of an LED lamp module through series and parallel connections according to the related art. With reference to FIG. 1, in a case in which current in the entirety of the LED lamp module is controlled by a single converter, when an abnormality occurs in any one group of LED elements and the LED elements fail to operate normally, current flowing in the abnormal group may be added to another group of LED elements, causing overcurrent. If this phenomenon persists, the entirety of the LED lamp module may not be used.

For this reason, as illustrated in FIGS. 2 and 3, the related art LED lighting device may use a power supply (a converter) capable of supplying power to the whole load of the LED lamp module as a main driver and use individual constant current drivers for each group to protect the LED lamp module.

FIG. 2 illustrates the configuration of additional constant current drivers for each column, and FIG. 3 illustrates the configuration of the constant current driver of FIG. 2.

However, this technology requires several to ten or more driver circuits in the case of an LED lighting device having a large capacity of hundreds of watts or greater. For this reason, the circuit configuration may be complicated and the number of parts may increase, causing an increase in a defect generation rate. This may result in a rise in price of the LED lighting device and a reduction in lifespan thereof.

In addition, in order to achieve cost reduction, the LED lighting device is often configured by allowing power consumption for a single LED package to be at least 70% of the maximum capacity of power available in the LED elements, resulting in increasing heat generated in the LED elements and shortening the lifespan.

The power supply (the converter) applied to the LED lamp module having the above-described configuration may be a low voltage high current power supply having low output voltage and high output current. In this case, as illustrated in FIGS. 4 and 5, the power supply should use an electrolytic capacitor for removing ripples included in the output voltage as the output current increases, resulting in shortening the lifespan of the product.

That is, the lifespan of the electrolytic capacitor used in the power supply may affect the lifespan of the LED lighting device.

In a case in which the low voltage high current power supply is used, voltage drop may occur according to a line length from the converter to the LED lamp module, and there is a limitation in a distance between the converter and the LED lamp module.

That is, a distance between the LED lighting device and the converter is necessarily limited to several meters, and thus, the power supply should be installed inside the lighting device.

In the case of an LED streetlight, in consideration of the fact that lifespan of an LED lamp is significantly shorter than that of a power supply, the power supply may be installed in a lower portion (an inspection hole) of a light pole such that the replacement thereof may be facilitated.

This problem is not only limited to the streetlight, font also is serious in the case of a light tower having an LED lamp which is much higher than that of the streetlight.

A height of the light tower may vary from 15 m to 50 m, and the power supply is usually installed inside a distribution box located around the light tower.

That is, in the case of the light tower, a distance between the LED lamp and the power supply may be increased to at least 20 m up to 100 m or greater. In this case, the low voltage high current power supply may not be installed in the distribution box, but may be installed in the lighting device.

In addition, since several to tens of lighting devices are installed in the light tower, unlike the streetlight, a defect generation rate of the power supply in the light tower is much higher as compared to the streetlight.

If a problem occurs under these circumstances, whenever the power supply is replaced, an expensive crane should be used. This may lead to an increase in maintenance cost as well as difficulty in rapid reaction. Therefore, it may be difficult to realize a basic purpose of LEDs, which is to achieve energy saving.

In addition, as illustrated in FIGS. 6 and 7, a DC/AC converter for rectifying AC 220V when driving voltage of an LED module decreases and for decreasing high DC voltage supplied through power factor correction (PFC) of the rectified voltage to the driving voltage of the LED module at a range of DC 12V to DC 24V, is formed of various elements including a main transformer, a power transistor, and the like, constituting a half-bridge circuit, a pulse width modulation (PWM) controller controlling the circuit, and a switching driver. A rectifier diode and a smoothing inductor constituting an output filter applied to an AC/DC converter converting the converted AC into DC may be used. These elements may take up most of the cost of the power supply.

The above-described operation may lower the efficiency of the power supply. In addition, a considerable amount of heat generated by the aforementioned elements may increase the defect rate of the power supply and shorten the lifespan of the product.

### DISCLOSURE

### Technical Problem

An aspect of the present disclosure provides a light emitting diode (LED) lighting device including a power supply (a converter) capable of reducing cost by simplifying a circuit of the power supply, and supplying normal driving voltage to an LED lamp module, without the use of an electrolytic capacitor significantly affecting lifespan of the power supply.

In addition, there is provided the power supply appropriate for the purpose of the LED lighting device by reducing maintenance cost incurred at the time of replacement of the power supply having shorter lifespan than the LED lamp, by installing the power supply in a lower portion of a light tower or a light pole so that voltage drop does not occur even when the LED lamp and the power supply are distant from one another.

Furthermore, in the LED lighting device according to an exemplary embodiment of the present disclosure, the efficiency of the converter may be improved by providing power of a power factor matching unit as power of the LED lamp module without the use of a switching unit and an output filter of an existing power supply (converter). Accordingly, a high efficiency power supply superior to the existing converter may be provided.

### Technical Solution

According to an aspect of the present disclosure, there is provided a light emitting diode (LED) lighting device including an LED lamp module including at least one or more LED elements connected in series; a power supply connected to the LED lamp module, supplying driving power to the LED elements, and being configured as a high voltage low current power supply having a simplified circuit configuration from which a half-bridge circuit, an output smoothing circuit and an output-side electrolytic capacitor are removed, the power supply for an LED lamp module includes: an input filter removing noise induced from input power and including a fuse in order to protect a product from a surge caused by a lightning strike; a bridge rectifier connected to the input filter and rectifying alternating current (AC) input voltage to convert the rectified voltage into direct current (DC) voltage; a power factor matching unit connected to the bridge rectifier, uniformly maintaining the input DC voltage, improving power factors, and being configured to supply the driving power to the LED lamp module without a separate conversion circuit; an auxiliary power supply connected to an output terminal of the bridge rectifier and supplying the driving power to the power factor matching unit and a current sensor; and the current sensor detecting driving current supplied from the power factor matching unit to the LED lamp module in order to supply current in which the power factors are improved to the LED elements.

### Advantageous Effects

As set forth above, in a light emitting diode (LED) lighting device according to exemplary embodiments of the present disclosure, an LED lamp module may be designed in consideration of an optimal driving environment of an LED lamp aiming at reducing energy and extending lifespan, thereby minimizing heat generated at the time of driving the LED lamp. In addition, the LED lamp module may be designed to provide the maximum luminous flux with respect to driving current, thereby maximally satisfying lifespan expectancy required by the LED lighting device.

In addition, a power supply provided with the LED lamp module may be configured in a high voltage low current form, thereby supplying sufficient power without the use of an electrolytic capacitor enormously affecting the lifespan of the converter. By extending the lifespan of the power supply, which is much shorter than that of the LED lamp module, maintenance cost of the LED lighting device may be reduced.

Furthermore, the efficiency of the power supply may be improved to 95% to 97% as compared with the 90% to 93% efficiency of the existing power supply by simplifying a circuit of the power supply used for the LED lamp module and removing the factors causing decline of efficiency, whereby luminous efficiency of the LED lighting device may be improved.

In addition, a defect generation rate of the product may be reduced by significantly simplifying constituent elements, and cost reduction of the power supply may lead to cost reduction of the LED lighting device.

Furthermore, according to exemplary embodiments of the present disclosure, the power supply may be designed to have a high voltage low current form, such that voltage drop does not occur even when the power supply and the LED lamp are distant from one another. Accordingly, the power supply may be installed inside a streetlight and a security light or in a lower portion (an inspection hole) of a light pole and may be used without additional manipulation,

In a case in which the high voltage low current power supply according to the exemplary embodiment of the present disclosure is applied to a light tower, it may have a great effect as compared to the streetlight.

A height of the light tower may vary from about 10 m to 50 m, and a distance between the LED lamp and the power supply may be increased in consideration of neighboring lines, and several to tens of LEDs may be used.

The power supply of the light tower is usually installed inside a distribution box located around the light tower, which is intended to rapidly respond to difficulties in repairs and replacement when a problem occurs and to reduce maintenance cost. The high voltage low current power supply according to the exemplary embodiment of the present disclosure may not suffer from a voltage drop even when the distance between the LED lamp and the power supply is 100 m. Therefore, the power supply may be used as a built-in power supply and may also be installed in a lower portion of the streetlight located with a distance of about 10 m or greater and in the distribution box of the light tower located with a distance of approximately 100 m.

When the power supply having a lifespan much shorter than that of the LED lamp is replaced during the lifespan of the LED lamp, separate expensive equipment is not necessarily used. Therefore, rapid response may be made and the maintenance cost may be highly reduced, whereby a product appropriate for the purpose of the LED lighting device, that is, long lifespan and energy saving, may be provided.

### DESCRIPTION OF DRAWINGS

FIG. 1 is a view illustrating the configuration of a light emitting diode (LED) lamp module connected in series and parallel according to the related art.

FIG. 2 illustrates the configuration of additional constant current drivers for each column.

FIG. 3 illustrates the configuration of the constant current driver of FIG. 2.

FIG. 4 is a circuit diagram of a power supply using an electrolytic capacitor for removing ripples from output voltage.

FIG. 5 is a perspective view of a power supply using an electrolytic capacitor for removing ripples from output voltage.

FIG. 6 is a block diagram, of a converter applied to an LED module having low driving voltage according to the related art.

FIG. 7 is a circuit diagram of a converter applied to an LED module having low driving voltage according to the related art.

FIG. 8 illustrates the configuration of a lighting device according to an exemplary embodiment of the present disclosure.

FIG. 9 is a block diagram of a power supply used in a lighting device according to an exemplary embodiment of the present disclosure.

FIG. 10 is a circuit diagram of a power supply used in a lighting device according to an exemplary embodiment of the present disclosure.

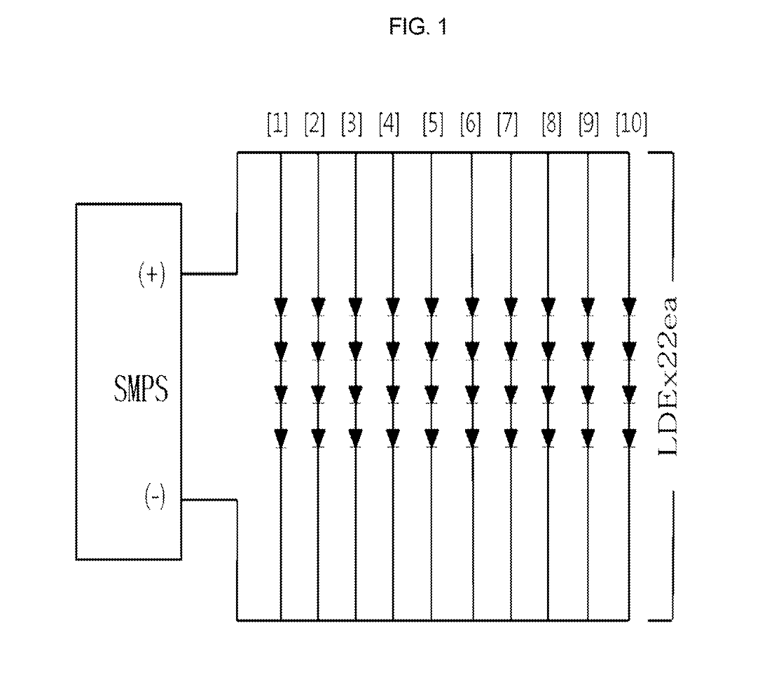

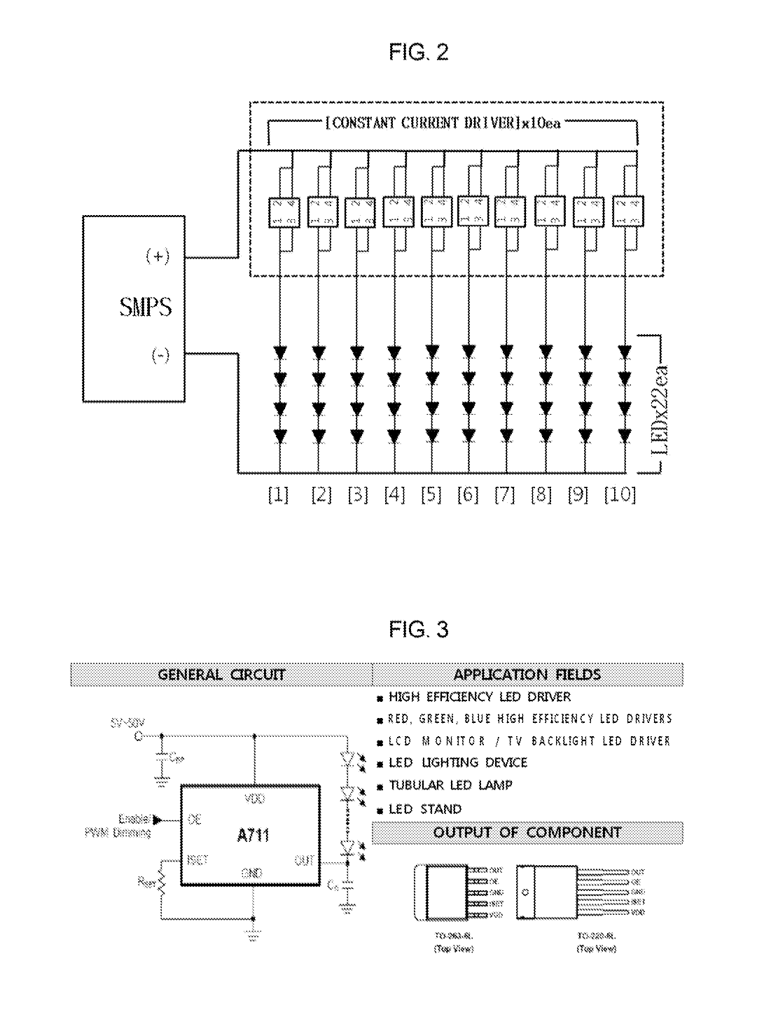

### MODE FOR INVENTION

Exemplary embodiments of the present disclosure will now be described in detail with reference to the accompanying drawings.

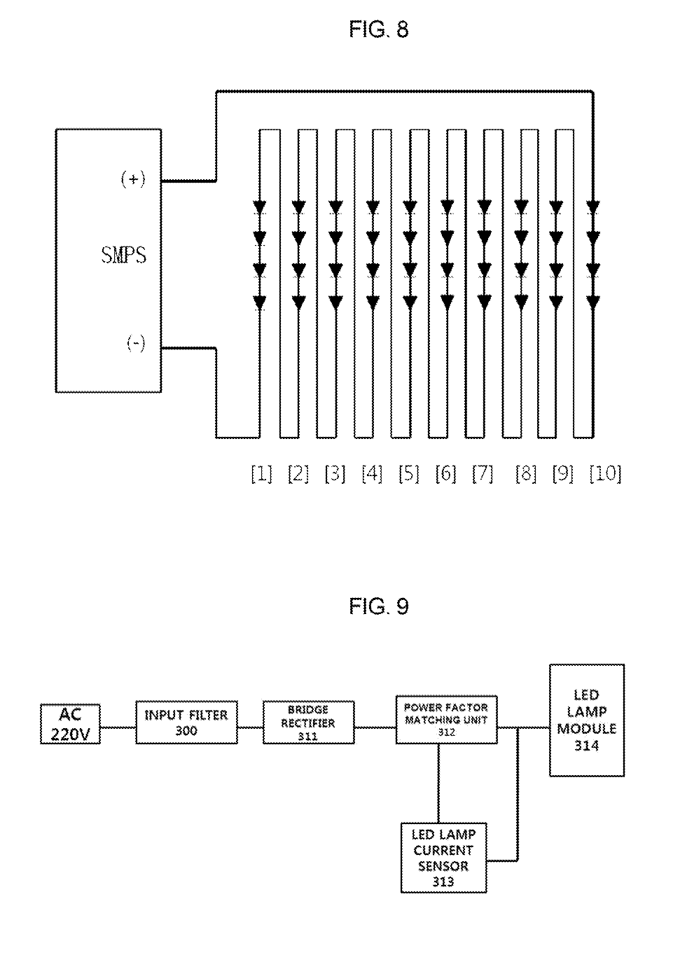

FIG. 8 illustrates the configuration of a lighting device according to an exemplary embodiment of the present disclosure.

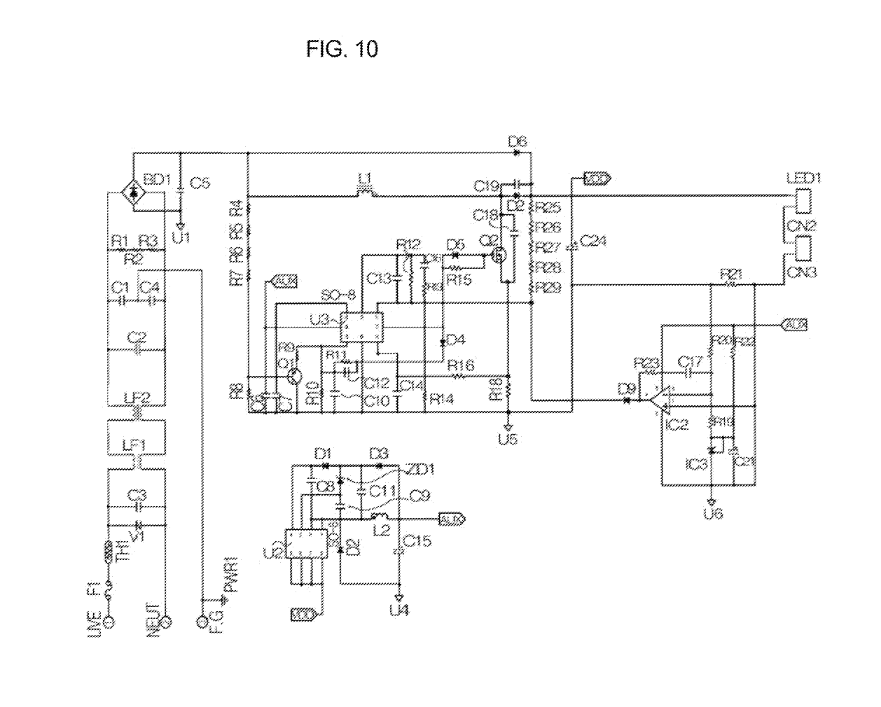

FIG. 9 is a block diagram of a power supply used in a lighting device according to an exemplary embodiment of the present disclosure, and FIG. 10 is a circuit diagram of a power supply used in a lighting device according to an exemplary embodiment of the present disclosure.

The lighting device according to the exemplary embodiment of the present disclosure may include at least one or more light emitting diode (LED) lamp modules and a switching mode power supply (SMPS) receiving electrical energy from an external power source to drive the LED lamp module.

At least one or more LED lamp modules according to this exemplary embodiment, as illustrated, may be arranged in series. In addition, the SMPS may convert AC power into DC power and supply the converted power having high frequency to the LED lamp modules.

Hereinafter, details related to determination regarding the number of LED elements will be provided.

[Table 1] illustrates luminous flux of light emitted from the LED elements according to driving current based on a junction temperature of 25° C.

With reference to [Table 1], it can be seen that when the driving current is 350 mA, the luminous flux is 100%; and when the driving current Is doubled to 700 mA, the luminous flux should be 200%, but is lowered to 170%. Further, when the driving current is tripled to 1050 mA, the luminous flux is significantly lowered to 250%. The driving current at a point at which the junction temperature is lowest with respect to the luminous flux is 350 mA.

Meanwhile, [Table 2] is a graph illustrating the lifespan of LED elements according to power consumption.

With reference to [Table 2], when the LED elements consume 30% of available power capacity W, they have the longest lifespan. Therefore, in a case in which power consumed by the LED elements is calculated by applying the driving current of 350 mA at which the luminous flux is 100% to the LED elements, the LED elements may have the longest lifespan with respect to efficiency thereof when the power consumed by individual LED elements is 1.05 W.

By applying the above data to the LED lamp module, the power consumed by individual LED elements is calculated as 1 W, and the number of LED packages may be determined to be appropriate for the capacity of the LED lighting device. That is, the LED lamp module of the LED lighting device having a power capacity of 100 W includes 100 LEDs (100 W÷1 W=100). 100 LED packages having available power capacity of 354 are connected to one another in series to thereby configure an LED module printed circuit board (PCB). When the driving current of the LED module is 350 mA as described above and the driving voltage (Vf) applied to a single LED is DC 3V, 3V×100 ea=DC 300V.

Therefore, the LED lamp module according to the present embodiment may be driven with the driving current of 350 mA, and the driving voltage thereof may be determined through the above calculation according to the capacity of the LED lighting device.

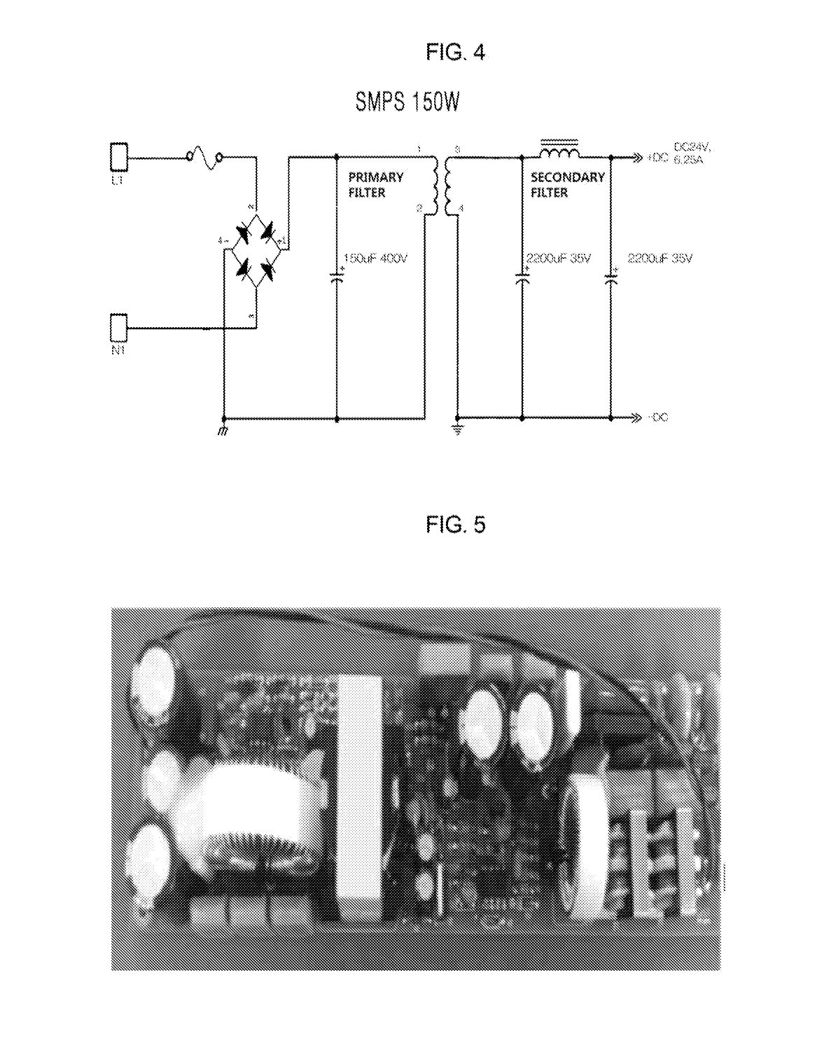

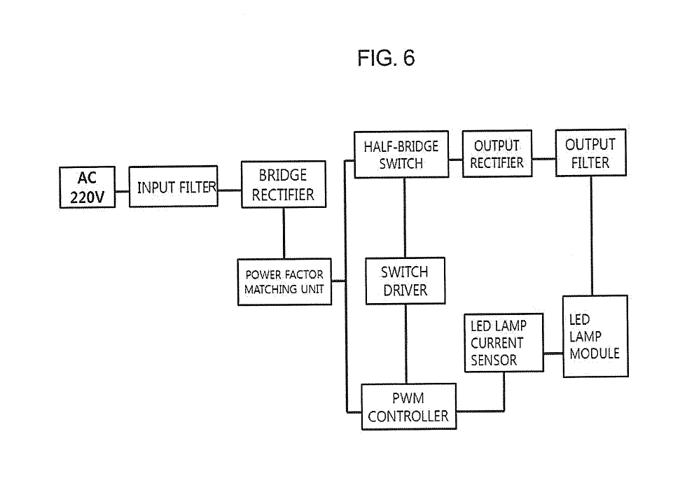

Meanwhile, a driving power source of the LED lamp module may be a device supplying output power of DC 300V and 0.35 A, such that consumed current becomes 0.35 A corresponding to approximately 30% of 1 A. Accordingly, there is no need for the use of an electrolytic capacitor applied to the power supply of FIGS. 4 and 5. As necessary, a film capacitor may be substituted therefor, and lifespan thereof is not considered.

Hereinafter, lifespan of a product according to types of capacitors will be described with reference to [Table 3] to [Table 5].

[Table 3] shows a lifespan calculation formula of an electrolytic capacitor, [Table 4] shows lifespan of a product to which an electrolytic capacitor is applied, and [Table 5] shows lifespan of a product to which a film capacitor is applied.

TABLE 3

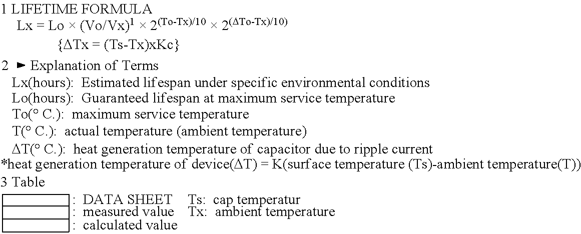

TABLE 4

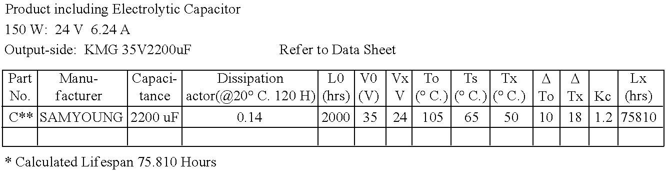

TABLE 5

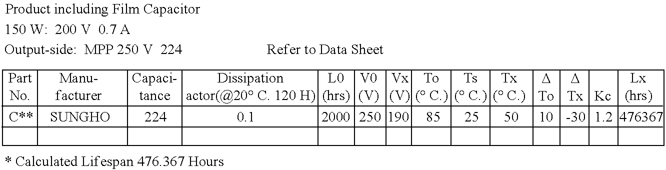

With reference to [Table 4] and [Table 5], when the lifespan of the product is calculated assuming that the electrolytic capacitor or the film capacitor is applied to the product, it can foe seen that the lifespan of the product significantly varies according to whether or not the electrolytic capacitor is used. In the exemplary embodiment of the present disclosure, the lifespan of the film, capacitor is calculated through substitution of the calculation formula of the electrolytic capacitor.

Hereinafter, a power supply according to an exemplary embodiment of the present disclosure will be described in detail. With reference to FIGS. 9 and 10, the power supply may include an input filter 300, a bridge rectifier 311, a power factor matching unit 312, an auxiliary power supply, and a current sensor.

Commercial electricity may be applied to an input terminal of the input filter, In the present embodiment, AC 220v is applied thereto.

The input filter 300 may include a fuse for blocking input power when an abnormality occurs. In a case of an abnormal state where an excessive amount of electricity exceeding rated current and rated voltage due to a short circuit, surge voltage caused by a lightning strike and the like, is received from an external power source, the electricity may be cut off in order to protect the power supply. In addition, the input filter may remove noise induced from the input power.

The bridge rectifier may be electrically connected to an output terminal of the input filter. The bridge rectifier 311 may include a general bridge rectifier circuit in order to convert input AC power to DC power. In addition, a smoothing circuit may foe additionally installed in order to uniformly maintain the output of the rectified DC power supply. In the bridge rectifier circuit, the rectified DC power supply may configure a low-pass filter circuit formed of an inductor and a condenser in order to remove ripples. The rectified DC power may be output to the power factor matching unit.

The power factor matching unit 312 may uniformly maintain input DC voltage, improve power factors, and supply driving voltage to the LED lamp module. The power factor matching unit may allow AC 220V from the bridge rectifier circuit to be rectified in a process of improving the power factors and obtain desired DC voltage through transforming and switching conversion of a power factor correction (PFC) circuit for improving the power factors of DC voltage from which the ripples are removed by the filter circuit. The power factors and harmonic distortion inevitably generated in the condenser input power may be improved. In addition, power efficiency may be improved by decreasing reactive power.

The LED lamp module may be connected to an output terminal of the power factor matching unit. The DC voltage obtained by the power factor matching unit may be applied to the LED lamp as the driving voltage of the LED lamp.

The current sensor may detect driving current supplied from the power factor matching unit to the LED lamp module and allow optimal current (in which power factors are improved) to be supplied to the LED elements.

Meanwhile, the auxiliary power supply connected to an output terminal of the bridge rectifier may supply driving power to the power factor matching unit and the current sensor.

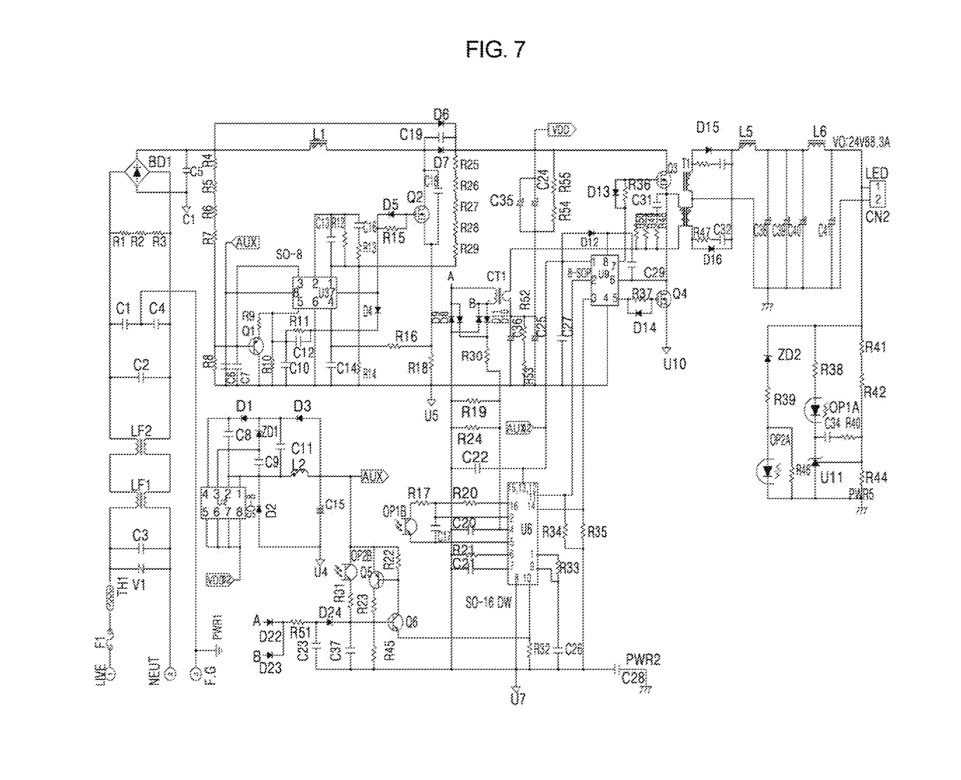

In the lighting device having the above-described configuration according to the exemplary embodiment of the present disclosure, sufficient power may be supplied to the LED lamp module, without a considerable number of circuits constituting a power supply having low output voltage and high output current according to the related art as illustrated in FIG. 7, such as a half-bridge circuit including transistors Q3 and Q4 for converting high voltage into low voltage, a DC/AC conversion transformer 11, a controller including a PWM controller integrated circuit (IC) U6, a peripheral circuit of a switching driver U9, rectifier diodes D15 and D16 and smoothing inductors L5 and L6 constituting an output-side filter, electrolytic capacitors C38 to C41 for removing ripples.

In general, decline in efficiency of a power supply may be due to loss generated in a rectifying process of an input-side bridge rectifier, loss caused in a switching process for power factor improvement of a power factor matching unit, and loss generated in a half-bridge switch, an output-side rectifier circuit and a filter for converting high voltage converted by the power factor matching unit Into low voltage required by an existing LED lamp module. According to the embodiment of the present disclosure, output conversion switching loss and loss that may be generated in rectifying and filtering processes may be minimized without the configuration of the half-bridge switch, the output-side rectifier, and the filter, whereby the circuit configuration according to the embodiment of the present disclosure may achieve an efficiency improvement of 5% to 7% as compared with the related art circuit configuration.

In addition, a reduced number of parts as compared with the related art circuit configuration may be used, whereby product cost may be dropped to approximately 50%.

While exemplary embodiments have been shown and described above, it will be apparent to those skilled in the art that modifications and variations could be made without departing from the spirit and scope of the present disclosure as defined by the appended claims.

1. A light emitting diode (LED) lighting device, comprising:
an LED lamp module including at least one or more LED elements connected in series;
a power supply connected to the LED lamp module, supplying driving power to the LED elements, and being configured as a high voltage low current power supply having a simplified circuit configuration from which a half-bridge circuit, an output smoothing circuit and an output-side electrolytic capacitor are removed,
the power supply for an LED lamp module includes:
an input filter removing noise induced from input power and including a fuse in order to protect a product from a surge caused by a lightning strike;
a bridge rectifier connected to the input filter and rectifying alternating current (AC) input voltage to convert the rectified voltage into direct current (DC) voltage;
a power factor matching unit connected to the bridge rectifier, uniformly maintaining the input DC voltage, improving power factors, and being configured to supply the driving power to the LED lamp module without a separate conversion circuit;
an auxiliary power supply connected to an output terminal of the bridge rectifier and supplying the driving power to the power factor matching unit and a current sensor; and
the current sensor detecting driving current supplied from, the power factor matching unit to the LED lamp module in order to supply current in which the power factors are improved to the LED elements.
